(19) United States
(12) Patent Application Publication
(10) Pub. No.: US 2004/0101043 A1
(43) Pub. Date: May 27, 2004

(54) Image encoding system

(75) Inventors: Julien Flack, Swanbourne (AU); Simon Fox, Heathmont (AU); Philip Victor Harman, Scarborough (AU)

Correspondence Address: BANNER & WITCOFF, 1001 G STREET N W, SUITE 1100, WASHINGTON, DC, 20001, US

(73) Assignee: Dynamic Digital Depth Research Pty Ltd, Bentley (AU)

(21) Appl. No.: 10/368,434

(22) Filed: Feb. 20, 2003

(30) Foreign Application Priority Data
Nov. 25, 2002 (AU) 2002952873

(51) Int. Cl. H04N 7/12

(52) U.S. Cl. 375/240.01; 375/240.26

(57) ABSTRACT

A method of encoding depth data within a video image wherein the depth data is included within an active picture area of the video image.

### FIELD OF INVENTION

The present invention is generally directed towards the display of stereoscopic images. The invention is designed to enable the recording, storage and playback of 2D video images, and an associated depth map, on standard video media.

### BACKGROUND

The present Applicants have previously disclosed in PCT/AU98/01005, hereby incorporated by reference in full, how a depth map could be compressed and imbedded in the VOB of a DVD file. This enabled the playing of such a depth map encoded DVD on a standard DVD player in 2D. As such the DVD was described as being “2D compatible” since a standard DVD player would decode the 2D image and ignore the additional depth data in the VOB.

The prior disclosure also described how a proprietary DVD player could be constructed that would extract the compressed depth map from the VOB, decompress it and combine it with the 2D image to form stereo, or multiple, images.

It will be appreciated that a special DVD player is required in order to implement this prior disclosure and display the stereoscopic image.

In a previous application, U.S. Ser. No. 10/125,565 included herewith in full by reference, the present Applicants disclosed a method of recording a 2D image plus associated depth map. This technique was not 2D compatible and would not enable a 2D compatible 3D image to be displayed using standard video equipment.

There is therefore a need to provide an improved method of storing depth information in a video signal such that it is minimally intrusive when played on a standard video display.

### OBJECT OF THE INVENTION

It is an object of this invention to disclose a technique that enables a 2D image and associated encoded depth map to be simultaneously recorded, stored and replayed on standard video media.

### SUMMARY OF THE INVENTION

With the above object in mind the present invention provides in one aspect a method of encoding depth data within a video image wherein said depth data is included within an active picture area of said video image.

The depth data can be stored as a sub picture.

In a further aspect the present invention provides a method of encoding depth data within a video image wherein said depth data is embedded in portions of said video image which are not subject to compression.

The depth data may be stored as MPEG user data or via other data hiding techniques such as watermarking.

The depth data may be distributed over a number of frames.

The invention discloses techniques for simultaneously recording a 2D image and associated encoded depth map onto video media. The technique enables standard video recording and playback process and equipment to be used to record, store and playback such composite images.

The invention also overcomes artifacts that would otherwise be generated as a by-product of video compression techniques used to format such 2D plus depth video images onto standard video media.

### IN THE DRAWINGS

FIG. 1 shows the format of a video signal.

FIG. 2 shows a frame of the 2D image illustrating the coordinate and colour information for a specific pixel.

FIG. 3 shows a neural network with 5 inputs 3 hidden layers of 8 nodes and a single output.

### DETAILED DESCRIPTION OF THE INVENTION

The present invention enables the simultaneous recording and storage of a 2D image and associated encoded depth map onto standard video media.

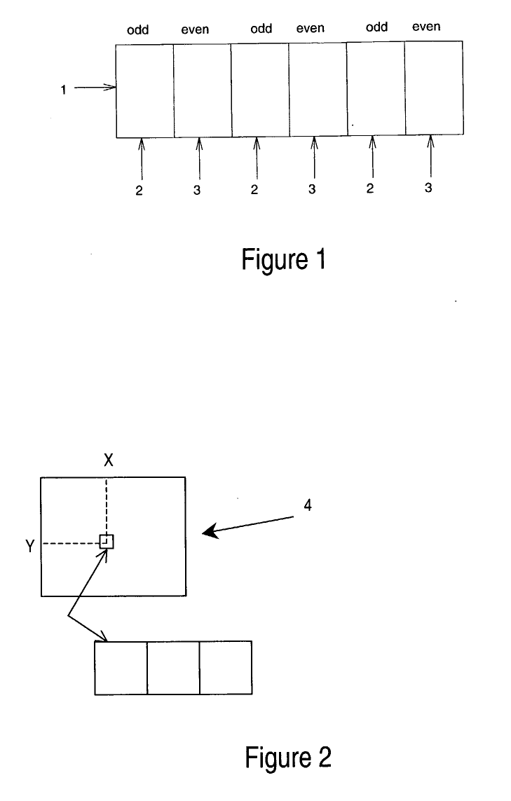

Analogue video images are commonly formatted in frames. In FIG. 1, three frames of a video signal are shown as 1. The time taken for each frame is dependant upon the video standard in use but is approximately 1/30 second for NTSC and 1/25 second for PAL.

Each frame is separated into two fields called the odd 2, and even 3, field as shown in FIG. 1.

For an NTSC video signal the odd field contains lines 1, 3, 5 etc to 525 and the even field contains lines 2, 4, 6 etc to 524. This technique is known as interlacing.

The Applicants previous application U.S. Ser. No. 10/125,565 disclosed that when analogue (e.g. NTSC and PAL) recordings of 2D images and associated depth maps are required one field may be used to record the 2D image and the other field the associated depth map.

It will be appreciated that this prior disclosure does not result in a standard video image and hence a video image encoded in this manner will not result in an acceptable 2D image when viewed on a standard video display device.

Data may be included in a video signal, such that it is not normally noticeable to a viewer, by including it in the video lines that are referred to as the vertical blanking interval (VBI). For standard NTSC video images these are lines 1 to 21 and 260 to 284. Such lines are normally outside of the visible viewing region of a standard video display and are therefore masked from the viewer.

Additionally, digital data may be included in the lines comprising the VBI, for example the international ‘Teletext’ service. Digital data may also be incorporated in a video signal using Closed Captioning techniques such us the service provided in the USA for the hearing impaired.

The present Applicants have previously disclosed in patents PCT/AU96/00820 and PCT/AU98/00716 that a depth map may be suitably encoded and included in the VBI of a standard video signal. Whilst this is an acceptable technique for analogue video signals there are a number of problems related to using this technique for digitally encoded video signals, such as MPEG2 encoded signal.

In particular, the DVD encoding standard, for NTSC video images, only supports the encoding of 480 lines of video. Hence for a standard 525-line NTSC video signal some 45 lines will not be encoded. In the Applicants experience consumer DVD players force these un-encoded lines to a black level. These un-encoded lines include the VBI lines of an analogue video signal; hence Teletext type data services are not available on a DVD. It is understood that, in NTSC format, the DVD specification does allow for closed captioning data to be included in Line 21. However, it is also understood that not all DVD players will display the caption data correctly.

Since the DVD standard only allows for 480 visible lines, and it is desired to maintain 2D compatibility and the use of a standard domestic DVD player for playback, the depth map data has to be displayed within these visible lines. That is, the depth data will be stored within the active picture area.

In a previous patent, PCT/AU01/00975 hereby included in full by reference, the present Applicants disclosed the use of a Machine Learning Algorithm (MLA) to produce and encode depth maps. The Applicants disclosed how a typical depth map could be fully described by using approximately 200 bytes/video frame.

A MLA encodes the relationship between a number of inputs and a number of outputs. In the present invention the inputs represent the video signal and the outputs represent the depth map. A MLA may be trained by providing examples of the inputs with the correct outputs. That is to say, at certain key frames both the video signal and the associated depth map data may be specified. The trained MLA then effectively encapsulates information relating the video signal to the depth map, which can be used for compression.

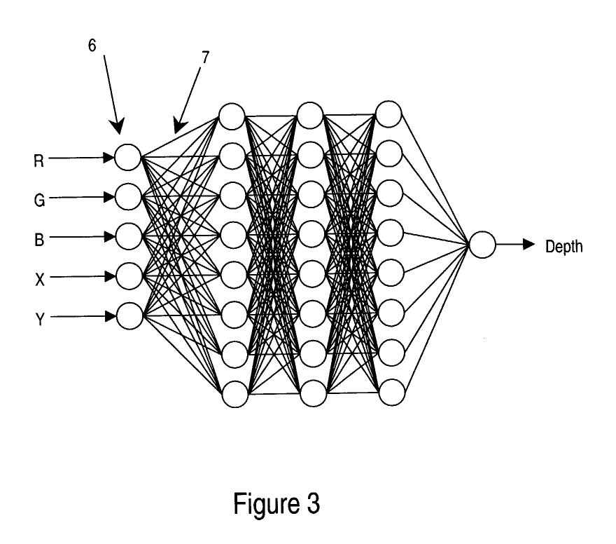

In the preferred embodiment, a feed forward multi-layer perceptron neural network is used as the MLA. The neural network is configured with 5 inputs representing the 3 colour components and 2 spatial components of the video signal. The output of the neural network is the corresponding depth value of the video signal. FIG. 2 illustrates a frame of the video signal 4, containing a pixel 5 at a location X,Y with colour R,G,B representing the red, green and blue colour components, respectively. FIG. 3 illustrates how a neural network, comprising of a series of nodes 6, and connections between nodes 7, calculate a depth value from the R,G,B,X,Y inputs of a pixel in the video signal.

The relationship between the video signal and the depth map encoded by a neural network degrades over time. A neural network trained at any given frame of the video signal will produce depth maps with increasing errors on successive frames. For example, we may find that a neural network trained at frame 10 of the video signal can only produce acceptable depth maps for frames 10 to 50, and that depth maps produced from frame 50 onwards contain too many errors.

The duration over which a neural network remains valid depends on the amount of motion in the video signal and the tolerance for errors in the depth map. In video signals containing a large degree of motion depth maps derived from a neural network degrade more quickly than in a video signal with little or no motion.

In the preferred embodiment the degradation of depth maps over time is addressed by providing a new or updated neural network at specified key frames of the video signal. This process is described in detail in prior disclosure U.S. Ser. No. 10/164,005 which is included herewith in full by reference.

Ideally each key frame contains some data for training a neural network. This training data includes both the inputs and the desired output of the neural network. For example, a single training sample may encode that the pixel of the video signal at row 100, column 100 with an RGB colour code of 100,0,0 has a depth of 50.

A multi-layer perceptron neural network includes a number of interconnected perceptrons or nodes as illustrated in FIG. 3. Each connection, 7 has an associated weight and each node, 6 has a bias. Given that the structure of the network is fixed in the present invention the network may be encoded as a collection of weight and bias values. The floating point values representing the network weights and biases generally vary around zero with an extreme range of approximately −12 to +12. Although values may fall outside of this range, clipping them has no detrimental affect on the network. For efficiently encoding these values we use a floating point format with one sign bit, four mantissa bits and three exponent bits. The four mantissa bits store the normalized fractional component of the floating point number in increments of 1/16 with an offset of 1/32 to spread the error evenly. The three exponent bits encode values from −4 to +3 using base 2 numbers. This arrangement provides a range of −15.75 to +15.75 which is sufficiently accurate for encoding neural networks.

A network with five inputs, three hidden layers of eight nodes each and a single output has 30 nodes and 176 connections. Only the nodes in the hidden layer and the final depth mode have bias values, meaning that we need to encode 201 floating point values. Each value can be encoded in a single byte using the floating point format described above leading to a total size of 201 bytes for encoding the neural network.

It will be appreciated that any other MLA may be used instead of a neural network including, but not limited to decision trees, model trees, decision graphs or nearest-neighbour classifiers.

If the MLA data would be treated as part of the standard video signal i.e. one of the valid 480 lines, then such encoded data would be subject to MPEG encoding as part of the DVD production process. Such processing would render the data unusable.

The DVD standard allows for sub pictures which are typically used for including language specific subtitles. The size of such sub pictures is defined in pixels, for example x pixels long by y pixels high. The intent of such sub pictures is to efficiently encode CGI text for the display of subtitles. As such, sub pictures are not subject to MPEG encoding. There is a limit of 1440 bits per line within the sub picture. The DVD standard provides for a maximum of 4 different colours for each pixel within the sub picture. In the worst case, if every consecutive pixel were different, then 360 pixels would be available per line. Since the sub picture data is Run Length Encoded in practice 720 bits per line are available. Given that the MLA typically requires 200 bytes of data such data needs may be achieved using two lines of sub picture.

In an alternative embodiment, the MLA data may be distributed over a number of frames of the video signal. As described, MLA data is only defined at certain key frames—the remaining frames of the video signal are used to distribute the MLA data more evenly. For example, if we have a key frame at frame 10 of the video signal and another key frame at frame 20 then we can encode 1/10th of the MLA data for the key frame at frame 20 in each of the frames 11-20.

It will be appreciated that the MLA data, i.e. the depth data, may be embedded in other parts of a video signal provided that the data is not corrupted by lossy compression and is suitably synchronized with the video signal. This includes areas of the active picture area of a video image. Mechanisms for embedding the MLA data in this way include, but are not limited to MPEG user data areas or data hiding techniques, such as watermarking, which are immune to the video distortions introduced by MPEG encoders.

Watermarking may be used to enable the source of an original digital image to be identified. Watermarking is typically applied to a DVD such that a known pattern of data is placed in the low order bits of the digitised video image. Such bits can be distributed throughout the image and since only low order bits are used to hold the watermarking data they have negligible effect on the overall quality of the video image once decoded. In a similar manner the MLA training data can be included in place of, or in addition to, watermarking data. Those skilled in the art will be aware of other image watermarking techniques that could be similarly used to store the MLA training data.

In effect, for DVD encoding, a small subtitle box is being generated that, rather than containing conventional subtitle text, contains coloured pixels that represent the MLA or depth data.

It will be appreciated that there is some inherent compression in the sub-picture, in particular run-length encoding. However this may be considered a loss less compression process as opposed to the MPEG encoding which can be considered lossy. The key is the ability to ensure that the depth data placed in the active picture area of the video image, for example in a sub-picture box, will be available following decoding. Thus whilst all areas of the image may have some inherent compression for the purposes of this description we will consider that areas such as sub-pictures which are not subject to lossy compression due to MPEG or the like are compression free.

Since the DVD specification allows for a sub picture box to be placed anywhere on the video image the depth map data could be positioned anywhere on the screen. In practice, in order to have minimum disturbance to the 2D image, the data is placed at the start of the image, the bottom of the image or a vertical row at either, or both, sides of the image. In a preferred embodiment this box will be placed at the last two lines of the active picture area since this allows it to be hidden in any over-scan region of the video display device and is hence not visible to the viewer should the viewer mistakenly activate the 3D mode whilst watching on a 2D display. This location is also preferred since the depth map data for the subsequent image may be provided prior to the vertical blanking interval. This interval provides time to fully decode and process the depth map prior to the arrival of the next 2D image.

Since the sub-picture is only displayed when the DVD is played in 3D there is no degradation of the image when played conventionally in 2D.

When viewing in 3D mode the sub-picture containing the MLA data will be enabled using standard DVD menu techniques that will be familiar to those skilled in the art. An example of suitable DVD encoding software that enables the production of MLA encoded sub pictures is ReelDVD by Sonic Solutions.

It will be appreciated by those skilled in the art that the decoding of the MLA data is simply achieved by counting the number of lines in the video signal from the DVD player. Once the counter has reached the lines containing the MLA data then this can be captured and processed into the original data stream.

The MLA data is then used to reconstruct the depth map within the decoding device. In the preferred embodiment the depth map is reconstructed from the video signal and the encoded neural network. Each pixel of the video signal provides the five inputs to the neural network. These inputs are propagated through the neural network represented by the encoded weights and bias values. The output of the network is the depth map value at the same pixel location as the input video signal.

To reduce the amount of calculations required to reconstruct the depth map a reduced resolution video signal may be used. For example, instead of passing every pixel of the video signal through the neural network only every 4th pixel is processed. This would lead to a depth map that is a quarter of the video signal resolution.

In an alternative embodiment improved depth maps may be generated by combining the outputs of two or more neural networks. For example, in a video signal containing key frames at frame 10 and frame 20 the generation of a depth at frame 15 may be an average of the outputs from the neural network at frame 10 and the neural network at frame 20. This process is described more fully in our previous disclosure U.S. Ser. No. 10/164,005.

It will be appreciated by those skilled in the art that the foregoing techniques of storing a 2D image and associated encoded depth map may be applied to any video medium including, although not limited to, digital and analogue video tape, DVD, DVD-R, CD, CD_ROM. In the case of analogue video tape e.g. a VHS video cassette, the depth map data may be included in any line that is preserved by the video processing system in use and output by the video cassette player. In a preferred embodiment the depth map data would be contained in a line of video towards the bottom of the image such that it is not visible to the viewer but masked in the video display over-scan area. It will also be appreciated that the same colour encoding of the depth map data, as used in the DVD process described, may be used with analogue videotape or other encoding techniques known to those skilled in the art, including although not limited to, Teletext and closed caption encoding.

The preceding disclosures enable the recording, storage and playback of 2D images and associated encoded depth maps using standard video media and existing video compression techniques, or more specifically the invention enables the production of 2D compatible 3D DVD's that can be played in 2D on a standard DVD player or in 3D using a suitable decoder.

It is not intended to restrict the application of this invention to the inclusion of an encoded depth map within a 2D video image. Rather, the technique may also be used for video images that have been either created using stereoscopic recording techniques or that were originated in 2D and subsequently passed through a 2D to 3D conversion process. Those skilled in the art will be familiar with the technique of recording stereoscopic images in a video sequence by storing one image in the odd fields and the other in the even fields. Such a technique is referred to as field sequential 3D video. It is also known that a DVD can be used to store such field sequential 3D video images. This present invention can also be applied to such stereoscopic recordings such that the decoded depth map may be used in conjunction with one or more of the stereoscopic image to either adjust the parallax of the resulting stereo image or create intermediate images between the stereo pair for use with Multiviewer 3D displays. It is not intended to restrict the scope of this invention to inclusion in stereoscopic video images comprised of a left and right eye image pair but to also cover multiple stereo images such as used by multiview stereoscopic display devices. That is depth data may be stored in a non lossy portion of the active picture area of an image whether the image be 2D or 3D.

It will be appreciated by those skilled in the art that the invention disclosed may be implemented in a number of alternative configurations. It is not intended to limit the scope of the invention by restricting the implementation to the embodiment described.

1. A method of encoding depth data within a video image wherein said depth data is included within an active picture area of said video image.

2. A method as claimed in claim 1 wherein said depth data is stored as sub pictures in said active picture area.

3. A method as claimed in claim 1 wherein said depth data is included within the last two lines of said active picture area.

4. A method as claimed in claim 1 wherein said depth data is stored at the end of said image.

5. A method as claimed in claim 1 wherein said depth data is included in a video over scan region of a video display.

6. A method as claimed in claim 1 wherein said depth data is stored at the start of said image, or at one or both sides of said image.

7. A method as claimed in claim 1 wherein said depth data is stored in a combination of the start of said image, end of said image, and/or at one or both sides of said image.

8. A method as claimed in claim 1 wherein said depth data is distributed over a plurality of frames of said video image.

9. A method as claimed in claim 2 wherein said depth data is distributed over a plurality of frames of said video image.

10. A method of encoding depth data within a video image wherein said depth data is embedded in portions of said video image which remain substantially uncompressed.

11. A method as claimed in claim 10 wherein said depth data is stored in MPEG user data areas.

12. A method as claimed in claim 10 wherein said depth data is stored as a watermark.

13. A method of encoding depth data within a video image wherein said depth data is embedded in portions of said video image which are only subject to substantially loss less compression.

14. An image encoded with depth data wherein said depth data is encoded within an active picture area of said image.

15. An image as claimed in claim 14 wherein said depth data is encoded as a sub picture within said active picture area.

16. An image as claimed in claim 14 wherein said depth data is encoded within the last 2 lines of said active picture area.
